(19) United States
(12) Patent Application Publication
(10) Pub. No.: US 2022/0000708 A1
(43) Pub. Date: Jan. 6, 2022

(54) BOTH SIDES UTILIZED BALL

(71) Applicant: Shenzhen miniplus health technology co.,Ltd., Shenzhen (CN)

(72) Inventor: Fangding YU, Shenzhen (CN)

(21) Appl. No.: 17/403,275

(22) Filed: Aug. 16, 2021

(30) Foreign Application Priority Data
Aug. 6, 2021 (CN) 202110904368.0
Aug. 6, 2021 (CN) 202121834128.X

(51) Int. Cl. A61H 23/02

(52) U.S. Cl. CPC A61H 23/0263; A61H 2201/0207; A61H 2023/0281

(57) ABSTRACT

Disclosed herein is a both sides utilized (BOSU) ball. The BOSU ball includes a main body and a vibration assembly. The main body is elastic, and the main body is capable of deforming when subjected to an external force and returning to an original shape when the external force is removed. The main body is configured to interact with a user to assist the user to exercise. The vibration assembly is connected to the main body, and the vibration assembly is configured to vibrate the main body to relax the user.

### CROSS-REFERENCE TO RELATED APPLICATIONS

This application claims the benefit of priority from Chinese Patent Application Nos. 202110904368.0 and 202121834128.X, respectively filed on Aug. 6, 2021 and Aug. 6, 2021. The content of the aforementioned applications, including any intervening amendments thereto, is incorporated herein by reference in its entirety.

### TECHNICAL FIELD

This application relates to gym equipment, and more particularity to a both sides utilized (BOSU) ball.

### BACKGROUND

Nowadays, the fast-paced modern lifestyle leads to the increasing pressure in work and daily life, and residents do not have enough time to do exercise to get rid of stress. In view of this, a household fitness facility, a both sides utilized (BOSU) ball, is developed, and the user can do various exercises with the help of the BOSU ball. Nevertheless, the existing BOSU balls cannot provide a massage effect, failing to fully relax the user.

### SUMMARY

Accordingly, an object of the present disclosure is to provide a BOSU ball with a massage effect.

To achieve the above object, the present disclosure provides a BOSU ball, comprising:

a main body, wherein the main body is elastic; the main body is capable of deforming when subjected to an external force and returning to an original shape when the external force is removed; and the main body is configured to interact with a user to assist the user to exercise; and a vibration assembly, wherein the vibration assembly is connected to the main body; and the vibration is configured to vibrate the main body to relax the user.

In some embodiments, the vibration assembly is arranged at a middle of the main body.

In some embodiments, the vibration assembly comprises a drive part and a first eccentric wheel; the first eccentric wheel is connected to the drive part; the drive part is connected to the main body; the drive part is configured to drive the first eccentric wheel to rotate eccentrically with respect to an axial direction of the drive part to allow the first eccentric wheel to generate a centrifugal force; and the drive part is also configured to transfer the centrifugal force generated by the first eccentric wheel to the main body so as to vibrate the main body.

In some embodiments, the vibration assembly further comprises a second eccentric wheel; the second eccentric wheel is connected to the drive part; the second eccentric wheel and the first eccentric wheel are spaced apart; the drive is configured to drive the first eccentric wheel and the second eccentric wheel to rotate eccentrically with respect to the axial direction of the drive part to allow the first eccentric wheel and the second eccentric wheel to generate a centrifugal force; and the drive part is also configured to transfer the centrifugal force generated by the first eccentric wheel and the second eccentric wheel to the main body so as to vibrate the main body.

In some embodiments, the first eccentric wheel and the second eccentric wheel are arranged at two ends of the drive part, respectively.

In some embodiments, a weight of the second eccentric wheel is different from a weight of the first eccentric wheel.

In some embodiments, the BOSU ball further comprises an energy supply part; the energy supply part is electrically connected to the vibration assembly; and the energy supply part is configured to supply power to the vibration assembly.

In some embodiments, an outer side wall of the main body is provided with a groove; and the vibration assembly is arranged in the groove.

In some embodiments, the BOSU ball further comprises a heating part; the heating part is connected to the main body; and the heating part is configured to heat the main body to a preset temperature.

In some embodiments, the main body further comprises a curve-surface part and a base plate; the curve-surface part is elastic; the curve-surface part is capable of being deformed when subjected to an external force and returning to an original shape when the external force is removed; the curve-surface part is connected to the vibration assembly; and the curve-surface part is arranged on the base plate to cover the base plate.

The beneficial effects of the present disclosure are described as follows.

A main body of a BOSU ball assists a user to do various exercises. The user has to keep balance during a deformation of the main body, such that the user can improve a sense of balance. The main body of the BOSU ball can automatically return to an original shape after the leaves the main body. In addition, the BOSU ball includes a vibration assembly, and the vibration assembly drives the main body to vibrate, so as to fully relax the user in contact with the main body and provide the user with a relaxing and pleasant sport experience.

### BRIEF DESCRIPTION OF THE DRAWINGS

Technical solutions of the present disclosure and the prior art will be described below with reference to the accompany drawings to be better understood. Obviously, the accompany drawings provided herein are part of the embodiments of the present disclosure, and other accompany drawings can be made by those skilled in the art without sparing creative work.

FIG. 1 is a sectional view of a BOSU ball according to an embodiment of the present disclosure;

FIG. 2 schematically depicts a structure of the BOSU ball according to an embodiment of the present disclosure;

FIG. 3 schematically depicts an arrangement of a vibration assembly in a mounting part;

FIG. 4 schematically depicts a structure of the vibration assembly;

FIG. 5 schematically depicts a structure of a second mounting part according to an embodiment of the present disclosure;

FIG. 6 schematically depicts a structure of a main body according to an embodiment of the present disclosure;

FIG. 7 schematically depicts a structure arranged in a groove of the main body according to an embodiment of the present disclosure;

FIG. 8 is a sectional view of the structure shown in FIG. 7;

FIG. 9 is a structure of the BOSU ball according to an embodiment of the present disclosure, and the main body, a cover part and a first mounting part are not shown;

FIG. 10 schematically depicts a structure of the BOSU ball according to another embodiment of the present disclosure;

FIG. 11 is an exploded view of the BOSU ball according to an embodiment of the present disclosure; and

FIG. 12 schematically depicts a structure of a remote controller according to an embodiment of the present disclosure.

In the drawings, 100, main body; 110, curve-surface part; 111, groove; 112, step; 120, base plate; 121, through hole; 130, connecting part; 200, vibration assembly; 210, drive part; 211; drive shaft; 212; drive body; 220, first eccentric wheel; 230, second eccentric wheel; 240, electric wire; 300, energy supply part; 310, energy supply cable; 400, cover part; 500, mounting part; 510, first mounting part; 520, second mounting part; 530, accommodating cavity; 531, first chamber; 532, second chamber; 600, fixing part; 700, heating part; 800, controller; 900, control button; 1000, rope-mounting part; 1010, mounting hole; 1100, remote controller; 1110, remote-control body; 1111, shell; 11111; first shell; 11112, second shell; 1112, control panel; 1113, ring; 1114, battery; and 1120, mechanical button.

The objectives, technical solutions and beneficial effects of the present disclosure will be further described below with reference to accompanying drawings herein.

### DETAILED DESCRIPTION OF EMBODIMENTS

Technical solutions of the present disclosure will be clearly and completely described below with reference to the embodiments and accompanying drawings.

Obviously, the embodiments provided herein are part of the embodiments of this disclosure, and other embodiments made by those skilled in the art without sparing creative work should fall within the scope of the present disclosure.

It should be noted that directional indications, such as up, down, left, right, front, back, are used to explain a relative positional relationship and movement between elements in a specific posture, and if the specific posture changes, the directional indication changes accordingly. In addition, terms such as “first” and “second” are illustrative, and should not be understood as indicating or implying a relative importance or the number of elements. Elements defined with “first” and “second” may explicitly or implicitly include at least one of the elements. Besides, the “and/or” used herein includes three solutions, for example, “A and/or B” includes A, B and a combination thereof. Additionally, technical solutions of various embodiments that do not conflict can be combined by those skilled in the art, and the combinations should fall within the scope of the present disclosure.

The structure of a BOSU ball will be specifically described below.

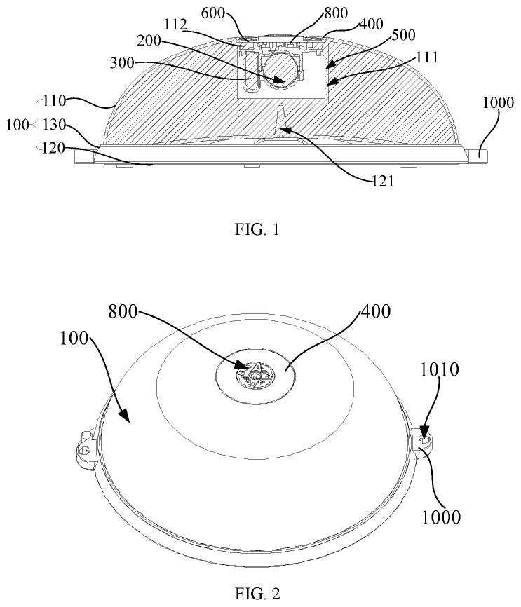

As shown in FIGS. 1-2, a BOSU ball includes a main body 100 and a vibration assembly 200. The main body 100 is elastic. The main body 100 is capable of deforming when subjected to an external force and returning to an original shape when the external force is removed. The main body 100 is configured to interact with a user to assist the user to exercise. The vibration assembly 200 is connected to the main body 100, and is configured to vibrate the main body 100 to relax the user.

The main body 100 assists the user to do various exercises. The main body 100 will deform when the user interacts with the main body 100, and the user may promote a sense of balance through keeping balance during the deformation of the main body 100. The main body 100 of the BOSU ball will automatically return to the original shape after the user leaves the main body 100. The BOSU ball provided herein includes the vibration assembly 200, and the vibration assembly 200 is capable of drive the main body 100 to vibrate, so as to fully relax the user in contact with the main body 100, providing the user with a relaxing and pleasant exercise experience.

In an embodiment, the various exercises include a push-up, a squat and stretching. Specifically, the user can do the push-up with a hand holding on the main body 100 of the BOSU ball. The user can also do the squat with a foot standing on the main body 100. In addition, the use can lie on the main body 100 for stretching. In some embodiments, the user can also do other suitable aerobic exercises with the BOSU ball.

In an embodiment, the main body 100 of the BOSU ball is made of a plastic material. Specifically, the plastic material is, but is not limited to, a rubber.

As shown in FIG. 1, in an embodiment, the vibration assembly 200 is arranged at a middle of the main body 100 of the BOSU ball, such that the vibration assembly 200 can evenly transfer vibration to various parts of the main body 100.

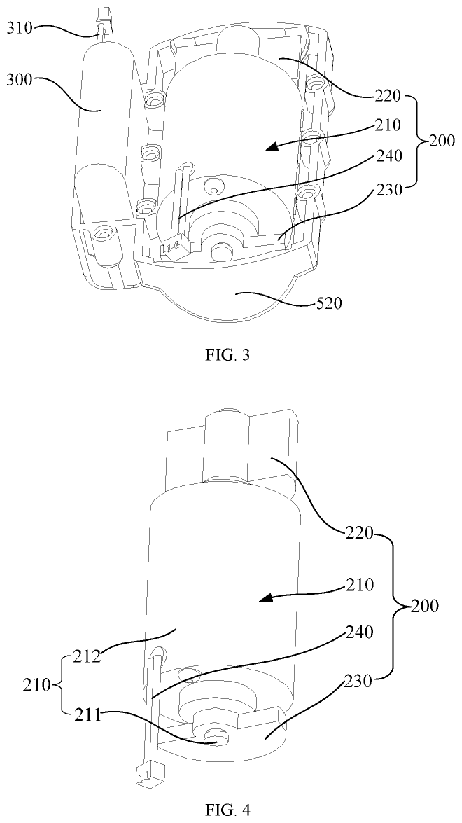

As shown in FIG. 3, in an embodiment, the vibration assembly 200 includes a drive part 210 and a first eccentric wheel 220. The drive part 210 is connected to the first eccentric wheel 220. The drive part 210 is connected to the main body 100 and is configured to drive the first eccentric wheel 220 to rotate eccentrically with respect to an axial direction of the drive part 210 to allow the first eccentric wheel 220 to generate a centrifugal force. In addition, the drive part 210 can transfer the centrifugal force generated by the first eccentric wheel 220 to the main body 100 so as to vibrate the main body 100. Specifically, the drive part 210 may be, but is not limited to, a motor, and the first eccentric wheel 220 may be, but is not limited to, an eccentric block.

As shown in FIG. 3, in an embodiment, the vibration assembly 200 further includes a second eccentric wheel 230. The vibration assembly 200 is connected to the drive part 210. The second eccentric wheel 230 and the first eccentric wheel 220 are spaced apart. The drive part 210 is configured to drive the first eccentric wheel 220 and the second eccentric wheel 230 to rotate eccentrically with respect to the axial direction of the drive part 210 such that the first eccentric wheel 220 and the second eccentric wheel 230 generate a centrifugal force. In addition, the drive part 210 can transfer the centrifugal force generated by the first eccentric wheel 220 and the second eccentric wheel 230 to the main body 100 so as to vibrate the main body 100. Specifically, the synchronous eccentric rotation of the first eccentric wheel 220 and the second eccentric wheel 230 with respect to the axial direction of the drive part 210 allow the main body 100 to vibrate more violently, which can better relax the user. In this embodiment, the first eccentric wheel 220 may be, but is not limited to, an eccentric block.

As shown in FIG. 3, in an embodiment, the first eccentric wheel 220 and the second eccentric wheel 230 are respectively arranged at two ends of the drive part 210, such that the first eccentric wheel 220 and the second eccentric wheel 230 can rotate synchronously and eccentrically with respect to the axial direction of the drive part 210 so as to drive the main body 100 to vibrate with a uniform amplitude.

In an embodiment, a weight of the second eccentric wheel 230 is different from a weight of the first eccentric wheel 220, such that when the first eccentric wheel 220 and the second eccentric wheel 230 rotate synchronously and eccentrically with respect to the axial direction of the drive part 210, a centrifugal force generated by the first eccentric wheel 220 and a centrifugal force generated by the second eccentric wheel 230 are different, and the two ends of the drive part 210 are shaken under the two different centrifugal forces, which further increases the amplitude of the main body 100.

As shown in FIGS. 3-4, in an embodiment, in the axial direction of the drive part 210, a thickness of the second eccentric wheel 230 is different from a thickness of the first eccentric wheel 220, such that the weight of the second eccentric wheel 230 is different from the weight of the first eccentric wheel 220. In this embodiment, in the axial direction of the drive part 210, the thickness of the second eccentric wheel 230 is less than the thickness of the first eccentric wheel 220, and therefore, the first eccentric wheel 220 is heavier than the second eccentric wheel 230. In some embodiments, in the axial direction of the drive part 210, the thickness of the second eccentric wheel 230 is larger than the thickness of the first eccentric wheel 220.

As shown in FIG. 4, in an embodiment, the drive part 210 includes a drive shaft 211 and a drive body 212. The drive shaft 211 is connected to the drive body 212. Part of the drive shaft 211 is inserted into the first eccentric wheel 220. The drive body 212 can drive the drive shaft 211 to rotate with respect to the axial direction of the drive shaft 211, so as to drive the first eccentric wheel 220 to eccentrically rotate with respect to the axial direction of the drive shaft 211 to allow the first eccentric wheel 220 to generate a centrifugal force. The generated centrifugal force is transferred to the main body 100 through the drive shaft 211 and the drive body 212 sequentially.

As shown in FIG. 4, in an embodiment, the drive shaft 211 protrudes from the two ends of the drive body 212. The second eccentric wheel 230 and the first eccentric wheel 220 are respectively sleeved on the two ends of the drive shaft 211. The drive body 212 can drive the drive shaft 211 to rotate with respect to the axial direction of the drive shaft 211, such that the first eccentric wheel 220 and the second eccentric wheel 230 can rotate eccentrically with respect to the axial direction of the drive shaft 211 to allow the first eccentric wheel 220 and the second eccentric wheel 230 to generate a centrifugal force. The centrifugal force is transferred to the main body 100 through the drive shaft 211 and the drive body 212 sequentially.

As shown in FIG. 3, in an embodiment, the BOSU ball also includes an energy supply part 300. The energy supply part 300 is connected to the vibration assembly 200, and is configured to supply power to the vibration assembly 200. Specifically, the energy supply part 300 is electrically contacted to the drive part 210 and is configured to supply power to the drive part 210. The energy supply part 300 may be, but is not limited to, a battery.

In an embodiment, the energy supply part 300 is a rechargeable power device. Specifically, when a power of the energy supply part 300 is run out, there is no need to replace the energy supply part 300, and the energy supply part 300 can be used again after being charged, which is convenient.

As shown in FIG. 3, in an embodiment, the energy supply part 300 includes an energy supply cable 310. The energy supply part 300 is configured to be electrically connected to an external power supply. The external power supply can charge the energy supply part 300 through the energy supply cable 310.

As shown in FIG. 1 and FIG. 6, in an embodiment, an outer wall of the main body 100 is provided with a groove 111. The vibration assembly 200 is arranged in the groove 111. Such arrangement increases space utilization. In addition, if the vibrating assembly 200 is put into the main body 100 of the BOSU ball after the main body 100 is packaged, the main body 100 has to be opened to put into the vibrating assembly 200, which may lead to air leakage of the main body 100 when in use. Whereas the vibrating assembly 200 provided herein is arranged in groove 11 and do not need to be put into the main body 100, avoiding the air leakage of the main body 100.

As shown in FIGS. 1-2 and 6, in an embodiment, the groove 11 is arranged at a center of the main body 100, such that the vibrating assembly 200 arranged in the groove 111 is at the center of the main body 100. Therefore, the vibrating assembly 200 can uniformly transmit vibration to various parts of the main body 100.

As shown in FIGS. 1-2 and 6, in an embodiment, a central axis of the groove 111 coincides with a central axis of the main body 100, such that the groove 111 is arranged at the center of the main body 100, and the vibrating assembly 200 arranged in the groove is at the center of the main body 100.

As shown in FIGS. 1-2, in an embodiment, the BOSU ball also includes a cover part 400. The cover part 400 is configured to cover an opening end of the groove 111 to block the groove 111. Specifically, the cover part 400 can cover the vibrating assembly 200 arranged in the groove 111, so as to provide the BOSU ball with a better appearance.

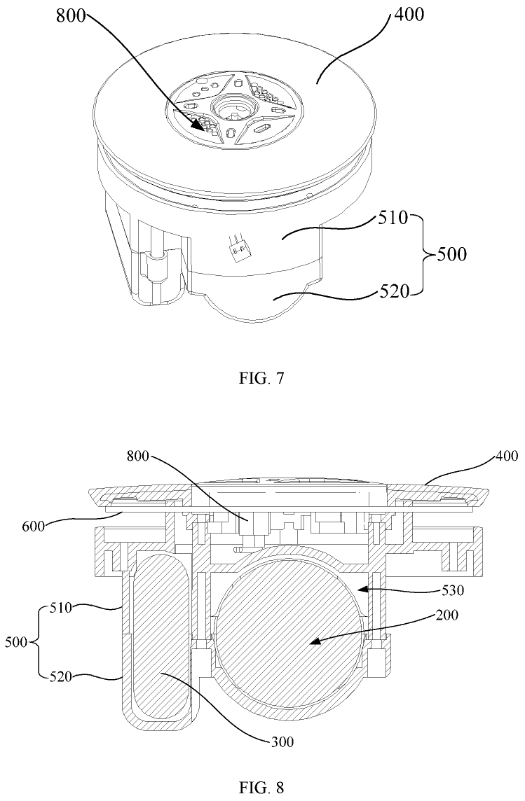

As shown in an embodiment in FIGS. 1 and 7, the BOSU ball also includes a mounting part 500. The vibration assembly 200 is arranged in the groove 111 through the mounting member 500. Specifically, the vibration assembly 200 vibrates the mounting part 500, and then the mounting part 500 vibrates the main body 100, so as to relax the user in contact with the main body 100.

As shown in FIGS. 1 and 7-8, in an embodiment, the mounting part 500 includes a first mounting part 510 and a second mounting part 520. The first mounting part 510 is connected to the second mounting part 520, and the first mounting part 510 and the second mounting part 520 are arranged in the groove 111. The first mounting part 510 and the second mounting part 520 are clapped to form an accommodating cavity 530, and the vibration assembly 200 is arranged in the accommodating cavity 530. Further, the vibration assembly 200 is arranged on a side of the second mounting part 520 facing the accommodating cavity 530.

As shown in FIG. 8, in an embodiment, the energy supply part 300 is arranged in the accommodating cavity 530.

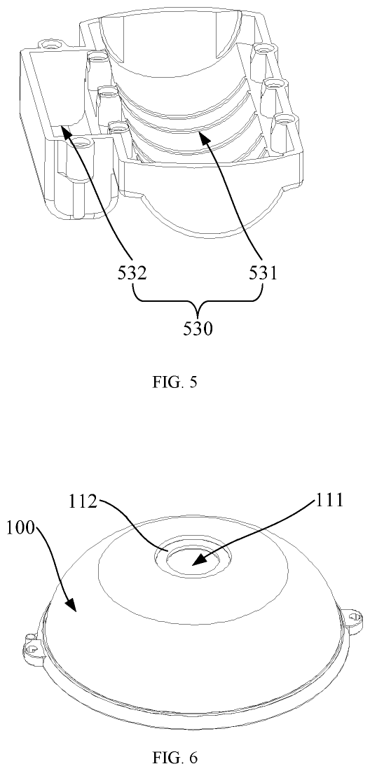

As shown in FIGS. 5 and 8, in an embodiment, the accommodating cavity 530 includes a first chamber 521 and a second chamber 522. The first chamber 521 and the second chamber 522 are spaced apart. The vibration assembly 200 is arranged in the first chamber 521, and the energy supply part 300 is arranged in the second chamber 522.

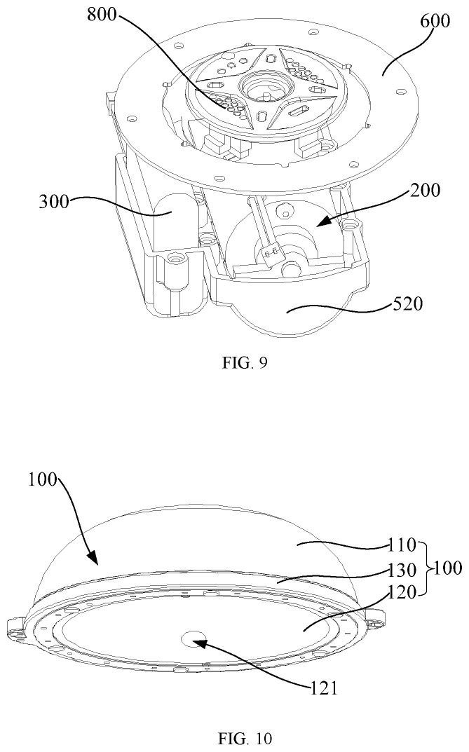

As shown in FIG. 9, in an embodiment, the BOSU ball also includes a fixing part 600, and is configured to fix the mounting part 500 in the groove 111.

As shown in FIGS. 1 and 9, in an embodiment, the fixing part 600 is arranged in the groove 111. The fixing part 600 is configured to abut against the mounting part 500, so as to fix the mounting part 500 with respect to the groove 111.

As shown in FIGS. 1 and 9, in an embodiment, the fixing part 600 is arranged on a side of the mounting part 500 close to the cover part 400.

As shown in FIGS. 1, 6 and 9, in an embodiment, an inner wall of the groove 111 is provided with a step 112. The fixing part 600 is arranged on the step 112 to fix the fixing part 600 with respect to the groove 111. Specifically, the fixing part 600 is arranged on the step 112 and abuts against the mounting part 500 to hinder a movement of the mounting part 500 in the groove 111, so as to fix the mounting part 500 with respect to the groove 111.

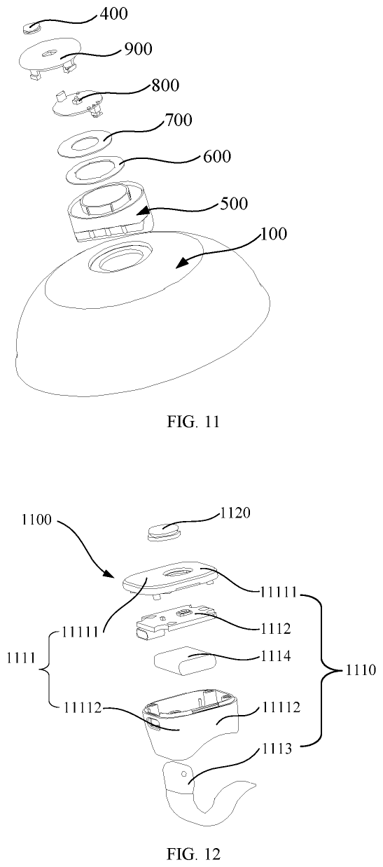

As shown in FIG. 11, in an embodiment, the BOSU ball also includes a heating part 700. The heating part 700 is connected to the main body 100, and is configured to heat the main body 100 to a preset temperature. Specifically, the preset temperature is a temperature to comfort the user. The preset temperature improves a sense of comfort for the user when the user is in contact with the main body. Specifically, the heating part 700 may be, but not limited to, a heating plate.

In an embodiment, the preset temperature is 37-55° C.

In an embodiment, the heating part 700 is arranged in the groove 111.

As shown in FIG. 9, in an embodiment, the BOSU ball also includes a controller 800. The controller 800 is electrically connected to the vibration assembly 200 to output a control signal to the vibration assembly 200, so as to control start and stop of the vibration assembly 200. The controller 800 improves the automation. In this embodiment, the controller 800 is configured to output the control signal to the drive part 210 to control the start and stop of the drive part 210.

In an embodiment, the control signal includes a first control signal and a second control signal. The controller 800 can output the first control signal to the vibration assembly 200 to control the start of the vibration assembly 200; and the controller 800 can output the second control signal to the vibration assembly 200 to control the stop of the vibration assembly 200. Specifically, the controller 800 outputs the first sub-control signal to the drive part 210, so as to control the drive part 210 to drive the first eccentric wheel 220 and the second eccentric wheel 230 to rotate synchronously and eccentrically with respect to the axial direction of the drive part 210. The controller 800 outputs the second sub-control signal to the drive part 210, so as to control the stop of the drive part 210.

As shown in FIG. 1, in an embodiment, the controller 800 is arranged in the groove 111. In this embodiment, the controller 800 is arranged on the mounting part 500. Specifically, the controller 800 is arranged on the first mounting part 510.

As shown in FIG. 3, in an embodiment, the vibration assembly 200 also includes an electric wire 240. The electron wire 240 is configured to electrically connect the drive part 210 to the controller 800.

As shown in FIG. 11, in an embodiment, the BOSU ball also includes a control button 900. The control button 900 is partially inserted into the cover 400. The control button 900 is configured to control the controller 800 to output the control signal to the vibration assembly 200.

In an embodiment, the control button 900 can be switched between a compressed state and a pop-up state through pressing the control button 900. When in the compressed state, the control button 900 is in contact with the controller 800, and the controller 800 outputs the first control signal to the vibration assembly 200. When in the pop-up state, the control button 900 is separated from the controller 800, and the controller 800 outputs the second control signal to the vibration assembly 200.

As shown in FIG. 12, in an embodiment, the BOSU ball also includes a remote controller 1100. The remote controller 1100 can communicate with the vibration assembly 200 through a signal, and the remote controller is configured to control the start and stop of the vibration assembly 200. Specifically, the remote control 1100 is convenient for the user to hold by hand. The user can control the start and stop of the vibration assembly 200 by the remote control 1100 as needed.

As shown in FIG. 12, in an embodiment, the remote control 1100 includes a remote-control body 1110 and a mechanical button 1120. Part of the mechanical button 1120 is partially inserted into the remote-control body 1110. The mechanical button 1120 can be switched between a compressed state and a pop-up state through pressing the mechanical button 1120, so as to control the start and stop of the vibration assembly 200. Specifically, when the mechanical button 1120 is in the compressed state, the vibration assembly 200 starts; and when the mechanical button 1120 is in the pop-up state, the vibration assembly 200 stops.

As shown in FIG. 12, in an embodiment, the remote-control body 1110 includes a shell 1111 and a control panel 1112. The control panel 1112 is arranged in the case 1111. Part of the mechanical button 1120 is inserted into the shell 1111. When in the compressed state, the mechanical button 1120 is in contact with the control panel 1112 so as to start the vibration assembly 200; and when in the pop-up state, the mechanical button 1120 is separated from the control panel 1112 so as to stop the vibration assembly 200.

As shown in FIG. 12, in an embodiment, the remote-control body 1110 further includes a ring 1113. The ring 1113 is connected to the shell 1111. The ring can be worn on a finger of the user, so that the remote controller 1100 is more portable and not easy to lose.

As shown in FIG. 12, in an embodiment, the remote-control body 1110 includes a battery 1114. The battery 114 is arranged in the shell 1111, and is electrically connected to the control panel 1112. The battery 1114 is configured to supply power to the control panel 1112.

As shown in FIG. 12, in an embodiment, the shell 1111 includes a first shell 11111 and a second shell 11112. The first shell 11111 is connected to the second shell 11112. The first shell 11111 and the second shell 1112 are clapped to form an accommodating space to accommodate the control panel 1112 and the battery 1114.

As shown in FIG. 10, in an embodiment, the main body 100 of the BOSU ball includes a curve-surface part 110 and a base plate 120. The curve-surface part 110 is elastic. The curve-surface part 110 is capable of being deformed when subjected to an external force and returning to an original shape when the external force is removed. The curve-surface part 110 is connected to the vibration assembly 210. The curve-surface part is arranged on the base plate 120 and covers the base plate 120. Specifically, a radian of the curve-surface part 110 helps the user to further improve the sense of balance when the user does various aerobic exercises with the BOSU ball. In this embodiment, the user can allow the base plate 120 or the curved-surface part 110 to face the ground as needed.

As shown in FIGS. 2 and 6, in an embodiment, the groove 111 is arranged on an outer side wall of the curve-surface part 110. In this embodiment, the curve-surface part 110 is made of a plastic material. Specifically, the plastic material may be, but not limited to, a rubber.

As shown in FIG. 10, in an embodiment, the curve-surface part 110 is hemispherical, and the base plate 120 is of a rounded shape. In some embodiment, the curve-surface part 110 may have other shapes to help the user to improve the sense of balance.

As shown in FIG. 10, in an embodiment, the main body 100 of the BOSU ball also includes a connecting part 130, and the connecting part 130 is configured to connect the curve-surface part 110 to the base plate 120.

In an embodiment, the main body 100 is inflatable and deflatable. Specifically, when user uses the BOSU ball for exercise, the main body 100 is in an inflated state.

As shown in FIG. 10, in an embodiment, a side wall of the main body 100 is provided with a through hole 121. The through hole 121 is communicated with an interior of the main body 100. The through hole 121 is configured to inflate of deflate the main body 100. Specifically, when in a deflated state, the main body 100 can be inflated through the through hole 121.

As shown in FIG. 10, in an embodiment, the through hole 121 is arranged on a bottom wall of the base plate 120.

In an embodiment, the BOSU ball also includes a rope, and the rope is arranged on the main body 100 for the user to handle. Specifically, the user can handle the rope for keeping balance when exercises with the assist of the main body 100.

In an embodiment, a plurality of ropes are arranged spaced apart on the main body 100. Specifically, the plurality of ropes help the user to better keep balance when being handled. In this embodiment, two ropes are provided, and the two ropes spaced apart are arranged on the main body 100. The two ropes are hold by two hands of the user, respectively, so as to help the user to keep balance.

As shown in FIG. 2, in an embodiment, the main body 100 also includes a rope-mounting part 1000 for mounting the rope. The rope-mounting part 1000 is arranged on the main body 100.

As shown in FIGS. 2 and 10, in an embodiment, the rope-mounting part 1000 is arranged on a side wall of the connecting part 130.

As shown in FIG. 2, in an embodiment, a plurality of the rope-mounting parts 1000 are provided, and the plurality of the rope-mounting parts is in one-to-one correspondence with the plurality of ropes.

As shown in FIG. 2, in an embodiment, the rope-mounting part 1000 is provided with a mounting hole 1010 for mounting the rope. Specifically, the rope can be arranged on the rope-mounting part 1000 through the mounting hole 1010.

The embodiments mentioned above are preferred embodiments of this disclosure, and not intended to limit the scope of the present disclosure. Changes made by those killed in the art and direct/indirect applications in other related technical fields without departing from the spirit of this disclosure should fall within the scope of the present disclosure defined by the appended claims.

What is claimed is:

1. A both sides utilized (BOSU) ball, comprising:
a main body; and
a vibration assembly,
wherein the main body is elastic; the main body is capable of deforming when subjected to an external force and returning to an original shape when the external force is removed; and the main body is configured to interact with a user to assist the user to exercise; and
the vibration assembly is connected to the main body; and the vibration assembly is configured to vibrate the main body to relax the user.

2. The BOSU ball of claim 1, wherein the vibration assembly is arranged at a middle of the main body.

3. The BOSU ball of claim 1, wherein the vibration assembly comprises a drive part and a first eccentric wheel; the first eccentric wheel is connected to the drive part; the drive part is connected to the main body; the drive part is configured to drive the first eccentric wheel to rotate eccentrically with respect to an axial direction of the drive part to allow the first eccentric wheel to generate a centrifugal force; and the drive part is also configured to transfer the centrifugal force generated by the first eccentric wheel to the main body so as to vibrate the main body.

4. The BOSU ball of claim 3, wherein the vibration assembly further comprises a second eccentric wheel; the second eccentric wheel is connected to the drive part; the second eccentric wheel and the first eccentric wheel are spaced apart; the drive part is configured to drive the first eccentric wheel and the second eccentric wheel to rotate eccentrically with respect to the axial direction of the drive part to allow the first eccentric wheel and the second eccentric wheel to generate a centrifugal force; and the drive part is also configured to transfer the centrifugal force generated by the first eccentric wheel and the second eccentric wheel to the main body so as to vibrate the main body.

5. The BOSU ball of claim 4, wherein the first eccentric wheel and the second eccentric wheel are arranged at two ends of the drive part, respectively.

6. The BOSU ball of claim 4, wherein a weight of the second eccentric wheel is different from a weight of the first eccentric wheel.

7. The BOSU ball of claim 1, further comprising:
an energy supply part;
wherein the energy supply part is electrically connected to the vibration assembly; and the energy supply part is configured to supply power to the vibration assembly.

8. The BOSU ball of claim 1, wherein an outer side wall of the main body is provided with a groove; and the vibration assembly is arranged in the groove.

9. The BOSU ball of claim 1, further comprising:
a heating part;
wherein the heating part is connected to the main body; and the heating part is configured to heat the main body to a preset temperature.

10. The BOSU ball of claim 1, wherein the main body further comprises a curve-surface part and a base plate; the curve-surface part is elastic; the curve-surface part is capable of being deformed when subjected to an external force and returning to an original shape when the external force is removed; the curve-surface part is connected to the vibration assembly; and the curve-surface part is arranged on the base plate to cover the base plate.
